(19) United States
(12) Patent Application Publication
(10) Pub. No.: US 2019/0172065 A1
(43) Pub. Date: Jun. 6, 2019

(54) RECONCILING COMMISSION BETWEEN WORKERS AND SERVICE PROVIDER COMPANIES BASED ON TRANSACTION HISTORY DATA

(71) Applicant: MasterCard International Incorporated, Purchase, NY (US)

(72) Inventors: Ahmed Hosny, Dublin (IE); Peter Groarke, Dublin (IE)

(21) Appl. No.: 15/833,065

(22) Filed: Dec. 6, 2017

(51) Int. Cl. G06Q 20/40

(52) U.S. Cl. CPC G06Q 20/405

(57) ABSTRACT

The disclosure facilitates a relationship between a worker and a service provider company by determining and enforcing commission balance thresholds between the worker and the service provider company. Transaction data associated with a service request assigned to a worker account of the worker is received. The transaction data is recorded to a transaction history data structure and a commission balance threshold between the worker and the service provider company is determined based on transaction history data of the transaction history data structure. A commission balance between the worker and service provider company is updated based on the transaction data. Upon the updated commission balance exceeding the commission balance threshold, the worker account is disabled, such that the worker is prevented from receiving new service requests. Dynamically determining commission balance thresholds provides workers with improved flexibility while maintaining the service provider company's ability to enforce balance-carrying limitations on its workers.

### BACKGROUND

In a modern “gig economy”, services are provided by workers employed by or in contract with service provider companies (e.g., Internet-based). For instance, car ride provider companies offer a platform for customers to request rides and for employee or contractor drivers to receive and fulfill the ride requests. The car ride provider company takes a commission from the fee charged to the customer and the driver receives the remaining portion of the fee as payment for the provided service. In many cases, the service provider company enables the customers to pay for services using credit card/account information or other types of electronic payment. In this case, the car ride provider company may track the amount paid for the services and pay drivers later, with the agreed upon commission kept by the car ride provider company.

In some situations (e.g., in particular regions, during particular time periods, etc.), many service transactions occur using cash or other similar in-person payment to the worker, rather than the payment going directly to the service provider company. The worker is responsible for reporting the transaction and paying the commission from the transaction to the service provider company. In order to ensure that workers regularly pay commissions for cash transactions, the service provider company may institute a policy that prevents a worker from receiving new service requests when the worker owes the service provider company more than a defined amount to the service provider company. Disabling the worker from receiving new service request encourages the worker to settle, or reconcile, the owed commission balance with the service provider company. However, enforcement of this policy can negatively affect the profitability of both the worker and the service provider company, by causing inefficient response to service requests by workers and missed opportunities to serve customers. Further, enforcement of the policy may be inappropriate in certain instances, such as in environments in which there are more cash payments than credit payments. Finally, a generally defined commission balance limit across all workers fails to account for the variety of different habits and behaviors of workers, potentially inhibiting the effectiveness of a portion of the workers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for determining and enforcing commission balance thresholds between a worker and a service provider company is described. The method comprises receiving transaction data associated with a service request assigned to a worker account of the worker, the worker account associated with the service provider company. The transaction data is recorded to a transaction history data structure associated with the worker and a commission balance threshold between the worker and the service provider company is determined based on transaction history data of the transaction history data structure, the transaction history data including the recorded transaction data. A commission balance between the worker and the service provider company is updated based on the transaction data, the commission balance representing an amount owed to either the worker or the service provider company. Upon the updated commission balance exceeding the commission balance threshold, the worker account is disabled, such that the worker is prevented from receiving new service requests.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is an exemplary block diagram illustrating a system configured for managing commission balances between a worker and a service provider company according to an embodiment;

FIG. 2 is an exemplary block diagram illustrating a commission manager configured for settling commission balances and managing commission balance thresholds according to an embodiment;

FIG. 3 is an exemplary flow chart illustrating managing commission balances between a worker and service provider company based on transaction history data according to an embodiment;

FIG. 4 is an exemplary flow chart illustrating managing commission balances between a worker and a service provider company as in FIG. 3, including settling commission balance differences between different service provider companies according to an embodiment; and

FIG. 5 illustrates a computing apparatus according to an embodiment as a functional block diagram.

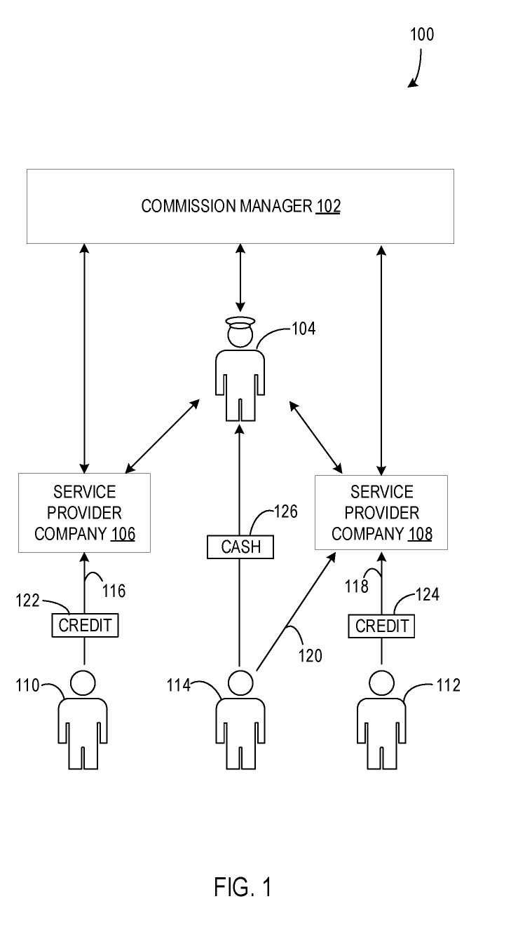

Corresponding reference characters indicate corresponding parts throughout the drawings. In FIGS. 1 to 5, the systems are illustrated as schematic drawings. The drawings may not be to scale.

### DETAILED DESCRIPTION

The systems and methods described herein are configured to facilitate a relationship between workers and service provider companies by determining and enforcing commission balance thresholds between the workers and service provider companies based on transaction history data. The disclosure enables dynamic, efficient control of commission balance limitations placed on workers with different thresholds being applied to specific workers. This enables a service provider company to make granular rule changes in order to emphasize aspects of worker behavior to incentivize, and accommodates the needs of workers in different regions.

Transaction data associated with a service request assigned to a worker account of the worker is received from the service provider company or the worker upon payment for the service (e.g., the worker provides transaction data after receiving a cash payment upon providing the service, the service provider company provides transaction data after receiving payment information electronically when the service is requested, etc.). The transaction data is recorded to a transaction history data structure (e.g., a relational database including rows of transaction data, a hierarchy of data files, or other type of data structure, etc.) associated with the worker. A commission balance threshold associated with the worker and the service provider company is determined based on transaction history data of the transaction history data structure, the transaction history data including the recorded transaction data. A commission balance between the worker and the service provider company is updated based on the transaction data. The commission balance represents an amount owed to either the worker or the service provider company. Upon the updated commission balance exceeding the commission balance threshold, the worker account is disabled, such that the worker is prevented from receiving new or future service requests.

Using transaction history data of a worker to determine commission balance thresholds that are specific to the worker (and specific to the service provider company in some instances) enables the worker to provide services with increased efficiency by avoiding situations where the productive worker's account may be become disabled. Further, the commission manager is able to combine the information for the worker from multiple, disparate service provider companies, enabling the worker to more easily manage commission balances, plan out when and where to provide services for the service provider companies, and determine when settling balances will be necessary. The ability of the commission manager to settle balance across multiple worker accounts further reduces the number of times the worker must manually settle balances with each of the service provider companies. With the disclosure, service provider companies can accurately monitor the behavior of workers and encourage good or efficient behavior by defining balance threshold rules. Risk associated with workers carrying commission balances can also be reduced by the use of cross-account settlement with other similar service provider companies.

The utility of the described commission manager may also provide transaction data storage redundancy to service provider companies, as well as, in some cases providing them with a more complete data set describing the behavior of workers with respect to other service provider companies. A worker's user-experience may also be enhanced due to dynamically receiving notifications about commission balance maintenance tasks in real-time based on location, time, and/or recognized behavior patterns.

FIG. 1 is an exemplary block diagram illustrating a system 100 configured for managing commission balances between a worker 104 and service provider companies 106 and 108 according to an embodiment. The worker 104 is employed by, under contract with, or otherwise has agreed to provide services (e.g., car rides, cleaning services, moving services, delivery services, tutoring and/or lecturing services, etc.) to clients of the service provider companies 106 and 108. The system 100 includes a commission manager 102, which is a software component controlled by or otherwise associated with an entity trusted by the service provider companies 106 and 108 (e.g., a bank, payment network, etc.). Alternatively, the commission manager 102 may be associated with a service provider company. In some examples, the commission manager 102 includes interfaces (e.g., application program interfaces (APIs), etc.) that enable communication and/or interaction with the worker 104, the service provider companies 106 and 108, and the clients 110, 112, and 114. Service provider companies 106 and 108 may integrate interactions with the commission manager 102 within their respective systems and/or applications.

For instance, a service provider company (e.g., service provider companies 106 and 108, etc.) may provide electronic applications (e.g., applications on mobile devices or other computing devices, web-based applications accessed via a web-portal, etc.) for use by workers (e.g., worker 104, etc.) and by clients (e.g., clients 110, 112, 114, etc.). The applications of the service provider company enable clients to place service requests (e.g., service requests 116, 118, and 120, etc.) with the service provider company and workers to receive and respond to clients' service requests, via a computing device using a network connection (e.g., a Wi-Fi connection, cellular network connection, etc.). The integration of the commission manager 102 with the service provider company applications (e.g., by application program interfaces provided by the commission manager 102 and/or the service provider company, etc.) further enables the commission manager 102 to settle, reconcile, or otherwise manage commission balances between the workers and service provider companies as described herein while allowing clients and workers to continue using the service provider company applications. Alternatively, or additionally, the commission manager 102 may also include applications for use by workers, clients, and service provider companies that are separate from applications of the service provider companies.

In some examples, the commission manager 102 is a software module that is installed and/or run on a computing device, such as a server, a personal computer, a laptop, a tablet, etc. Alternatively, or additionally, portions of the commission manager 102 may be installed and/or run on multiple different computing devices without departing from the description herein. The commission manager 102 records transaction data associated with transactions between workers and clients, workers and service provider companies, and clients and service provider companies in, for instance, computer storage media, such as one or more computer hard drives. In an example, client 110 makes a service request 116 to service provider company 106. Upon the worker 104 (e.g., a driver, a cleaner, a delivery person, a mover, etc.) receiving and fulfilling the client 110's service request, the client 110 makes a payment to the service provider company 106 from a credit card or account 122. The commission manager 102 receives transaction data associated with the payment made to service provider company 106 via an API exposed to the service provider company 106 by the commission manager 102. Further, client 112 makes a service request 118 to service provider company 108. Worker 104 also works for service provider company 108 and, upon the worker 104 receiving and fulfilling the client 112's service request, the client 112 makes a payment to the service provider company 108 from a credit card or account 122. Finally, client 114 makes a service request 120 to service provider company 108 as well. Upon the worker 104 receiving and fulfilling service request 120, client 114 makes a payment to the worker 104 directly using cash 126. The commission manager 102 receives transaction data associated with the payment of cash 126 to the worker 104 from the worker 104 via an API exposed to the worker 104 through an associated application.

In the case of credit card payments or other types of electronic payments, clients pay the service provider company electronically and the commission manager 102 receives the transaction data directly or from the service provider company, issuer, acquirer, payment network, or the like. However, in the case of cash payments or other types of payment that given directly to the worker, the worker reports and/or provides an advice of the transaction to the commission manager 102 for recording.

Additionally, the commission manager 102 may provide the worker 104 with information regarding the worker's commission balances with service provider companies for whom the worker works (e.g., via an application used by the worker 104, etc.). For instance, the worker 104 may receive notifications regarding commission balances as they change or otherwise be able to access and view commission balances for each service provider company. Further, the commission manager 102 may enable similar communications with service provider companies 106 and 108 regarding balances, as well as facilitating the settlement or reconciliation of commission balances between the service provider companies 106 and 108 and the worker 104 and/or between the service provider companies 106 and 108 themselves, as described below.

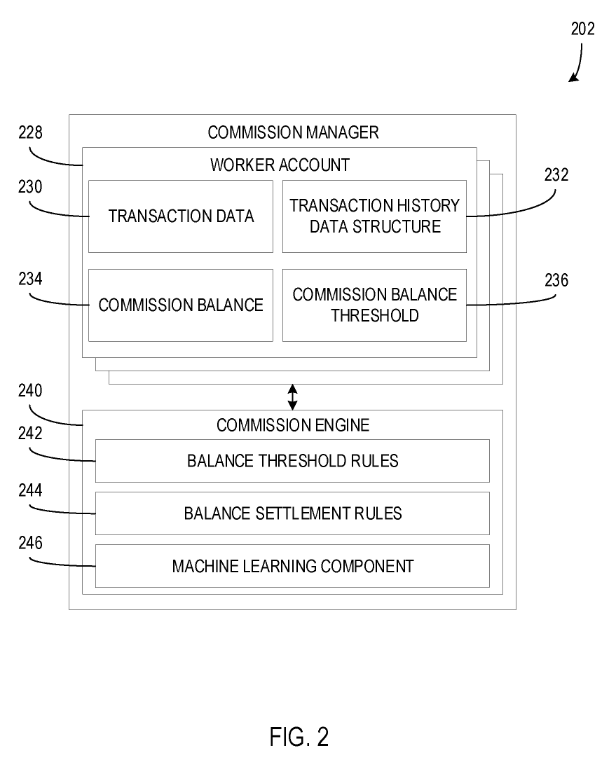

FIG. 2 is an exemplary block diagram illustrating a commission manager 202 configured for settling commission balances and managing commission balance thresholds according to an embodiment. The commission manager 202 includes worker accounts 228, and a commission engine 240.

Worker account 228 is software component of the commission manger 202 associated with a worker (e.g., worker 104, etc.) and a service provider company (e.g., service provider companies 106 and 108, etc.). A worker may be associated with more than one worker account 228 when the worker works for more than one service provider company. For instance, in FIG. 1, worker 104 may have two worker accounts 228; one worker account associated with service provider company 106 and a second worker account associated with service provider company 108.

A worker account 228 includes transaction data 230 that is received based on transactions between a worker and a client, a worker and a service provider company, or a client and a service provider company. When a client pays for a service, the transaction data 230 of that payment is received by the commission manage 202 at the worker account 228 associated with the worker who rendered the service. When a worker pays owed commission to a service provider company or a service provider company pays owed commission to a worker, that transaction data 230 is also received by the commission manager 202 and recorded in the appropriate worker account.

The received transaction data 230 is recorded in a transaction history data structure 232 of the worker account 228. In some examples, the transaction data 230 recorded in the transaction history data structure 232 includes parties to the transactions, amount of the transactions, date and time stamps of the transactions, type of transactions (e.g., cash, credit, electronic, etc.), status information associated with the transactions, categories associated with the transactions, locations associated with the transaction, or the like. Any data that is associated with a transaction may be stored in the transaction history data structure 232. However, transaction data storage may be limited to only the data points that are used by the commission manager 202 in the processes described herein.

The commission balance 234 of the worker account 228 indicates an amount owed by the worker of the worker account 228 to the service provider company of the worker account 228 or an amount owned by the service provider company to the worker. The commission manager 202 maintains an accurate commission balance 234 based on the transaction data 230 received as transactions occur. The worker and service provider company may have an agreement regarding the amount of commission the worker owes the service provider company for completing service requests. For instance, the worker may owe the service provider company 5% of all payments collected for completed service requests received through the service provider company. In this case, when the worker receives a $100 payment in cash, the worker reports the payment to the commission manager 202. The commission manager 202 updates the commission balance 234 by including the $5 (5% of $100) owed by the worker to the service provider company. Alternatively, when the worker completes a service request and the client pays using credit or an electronic payment method, the $100 payment may be transferred to the service provider company. The commission manager 202, upon receiving the transaction data 230 associated with the payment, updates the commission balance 234 by including the $95 ($100 less the 5% commission) owed by the service provider company to the worker. The commission balance 234 may be a signed value, such that a positive value indicates that the worker owes the service provider company and a negative value indicates that the service provider company owes the worker. Alternatively, the commission balance 234 may include an indicator (e.g., a Boolean value, etc.) that indicates whether the worker owes the service provider company or the service provider company owes the worker.

When the commission balance 234 indicates that the worker owes an amount that exceeds the commission balance threshold 236, the commission manager 202 may cause the worker account 228 to be disabled, such that the worker will no longer receive service requests from the service provider company associated with the worker account 228 until the commission balance 234 is settled.

In some examples, the commission balance threshold 236 may trigger alternative or additional enforcement responses when exceeded. For instance, a notification may be sent to the worker regarding the exceeded commission balance threshold 236. The worker may be given a defined time period during which the worker may still receive service requests from the service provider company. If the worker does not settle the commission balance 234 with the service provider company during the defined time period, the worker account 228 may then be disabled. Further, the commission manager 202 or an associated application on a computing device of the worker may direct the worker to a nearby bank or other entity at which the worker can settle a commission balance 234 that has exceeded or nearly exceeded a commission balance threshold 236.

Alternatively, or additionally, the commission balance threshold 236 may be based on an amount of time that the commission balance 234 has indicated that the worker owes the service provider company. For instance, the commission balance threshold 236 may be defined as three days, such that, when the worker has carried an owed commission balance 234 for longer than three days, the worker account 228 is disabled until the commission balance 234 is settled. In some examples, the commission manager 202 may use date-time data and transaction amount data to calculate a “velocity” (e.g., a value of transactions over time, etc.) of payments associated with the services provided by a worker and commission balance thresholds 236 may be determined based on the calculated velocity. A worker whose velocity is steadily increasing over the course of a week or a month may be given increasing commission balance thresholds 236 in response.

In an example, a commission balance threshold 236 may be associated with the service provider company owing the worker. For instance, a commission balance threshold 236 may be set to $500 owed by the service provider company to the worker. When the commission balance 234 meets or exceeds $500 owed from the service provider company to the worker, the commission manager 202 may cause an automated payment (e.g., transferring between bank accounts electronically, initiating a process to send a check to the worker, etc.) from the service provider company to the worker to settle the commission balance 234. This commission balance threshold 236 may further be adjusted based on transaction history data.

Multiple commission balance thresholds 236 may be defined at various commission balance values, associated time periods, or the like, and each commission balance threshold 236 may trigger different actions by the commission manager 202 as described herein.

The commission engine 240 is a software component of the commission manager 202 that uses balance threshold rules 242, balance settlement rules 244, and a machine learning component 246 to facilitate commission balance management of the worker account(s) 228. The balance threshold rules 242 are used in combination with the transaction history data of the transaction history data structure 232 to dynamically determine commission balance thresholds 236 for the associated worker account 228. Commission balance threshold rules 236 may be determined each time transaction data is received, at regular defined intervals (e.g., every 30 minutes, every hour, etc.), or at other times, such as defined events that trigger a determination (e.g., when a worker reports a cash payment, when a commission balance changes by a defined amount, or when a service provider company issues a command to cause a determination to occur, etc.). The transaction history data of a worker account 228 may be used to represent the associated worker's past behavior with respect to carrying and/or settling commission balances 234 with the associated service provider company. For instance, the transaction history data may indicate that the worker consistently settles commission balances within a reasonable time period, a frequency with which the worker settles commission balances, a frequency with which the worker exceeds commission balance thresholds, the worker always settles commission balances on a particular day of the week, the worker settles commission balances prior to the commission balance reaching a particular value, an average commission balance value carried by the worker, a ratio of cash transactions to total transaction collected by the worker, or the like. If the transaction history data indicates that the worker is reliable, a balance threshold rule 242 may cause the commission balance threshold 236 of the associated worker account 228 to be increased, representing that the worker is trustworthy enough to carry a larger commission balance 234. In some examples, transaction history data from other worker accounts associated with the worker and different service provider companies may also be used in combination with the balance threshold rules 242 to determine the commission balance thresholds 236.

In an example, a worker always settles the commission balance 234 of the worker account 228 with the associated service provider company on Friday afternoon. On Friday morning, the commission balance 234 approaches the currently defined commission balance threshold 236. Upon a new commission balance threshold 236 being determined, a balance threshold rule 242 is applied to the transaction data that causes the commission balance threshold 236 to be extended based on the detected balance settlement pattern of settling on Friday afternoon, giving the worker a chance to continue receiving service requests throughout the day and then settle the commission balance in the afternoon. For instance, the balance threshold rule 242 may include the following logic: “If a worker settles an outstanding commission balance in a two-hour time window on a particular day of the week at least 75% of the time, then increase the commission balance threshold twelve hours prior to the time window”.

In another example, if the transaction history data indicates that a particular region, area, or neighborhood has a high percentage of cash based transactions, a balance threshold rule 242 may cause a worker's threshold 236 to be increased when the worker is working in the particular region. This enables the worker to continue working in the high cash region without the worker's account 228 being disabled.

Other balance threshold rules 242 may be defined to identify many different patterns based on the worker's behavior and adjust threshold(s) 236 in response without departing from the description.

In some examples, the balance threshold rules 242 may be defined based on input provided by the service provider company and/or the worker. For instance, a service provider company may define a default commission balance threshold 236 to use for all worker accounts 228. The service provider company may further provide a variety of balance threshold rules 242 to identify worker behavior and adjust the commission balance thresholds 236 accordingly as described herein.

The balance settlement rules 244 are used in combination with the commission balances 234 across multiple worker accounts 228 as well as transaction history data of the transaction history data structures 232 to determine whether and how to settle the commission balances 234 across the associated multiple worker accounts 228. For instance, worker 104 in FIG. 1 is employed by the service provider companies 106 and 108 and commission manager 102 includes worker accounts of the worker 104 associated with both service provider companies. Each worker account has a commission balance between the worker 104 and the service provider company associated with the worker account. The commission balances of the worker accounts may indicate that the worker 104 owes the service provider company 108 $20 due to cash transactions (e.g., the payment to the worker 104 with cash 126, etc.) and that service provider company 106 owes the worker 104 $40 due to credit transactions (e.g., payments from credit accounts 122 and 124, etc.). The balance settlement rules 244 may be used to evaluate the two commission balances and determine whether and/or when to settle the commission balance differences between the worker accounts. In the above example, a portion of the $40 balance owed the worker 104 by the service provider company 106 may be used to settle the $20 balance that the worker 104 owes to the service provider company 108, such that, after the settlement, the service provider company 106 owes the worker 104 $20and the service provider company 108 and worker 104 have a settled commission balance.

Balance settlement rules 244 may cause settlement between worker accounts 228 based on the commission balances 234, defined time periods, and/or other transaction data from the transaction history data structure 232. For instance, balances 234 between worker accounts 230 may be settled when a balance settlement rule 244 indicates that the settlement prevents a commission balance 234 from exceeding a commission balance threshold 236 on one or more of the worker accounts 228. Alternatively, or additionally, the commission balances 234 may be settled between worker accounts 228 at a defined time every day, week, or month (e.g., the commission balances 234 are balanced between accounts 228 every night at 2 AM, etc.).

Balance settlement rules 244 may be defined by service provider companies associated with worker accounts 228. Service provider companies may limit the cross-account balance settlement as desired, particularly placing balance settlement rules 244 on when and how commission balances owed to the service provider company by the worker are used to settle balances owed to the worker by other service provider companies. Further, a service provider company may define balance settlement rules 244 that limit whether settlements are allowed with certain other service provider companies.

In an example, the balance settlement rules 244 cause the settlement of balances between worker accounts 228 whenever possible, potentially minimizing the number of service provider companies with which the worker must manually settle balances.

The machine learning component 246 provides updates, changes, and/or adjustments to the balance threshold rules 242 and/or the balance settlement rules 244 based on feedback from service provider companies and/or workers regarding the operation of the commission manager 202. For instance, service provider companies may rate the reliability of a worker over time, and those ratings may be provided to the machine learning component 246 as feedback with respect to the current balance threshold rules 242. If the feedback indicates that the worker is extremely reliable, the machine learning component 246 may adjust the balance threshold rules 242 (associated with the particular worker or generally) to provide the worker with higher and/or more generous commission balance thresholds 236. Alternatively, if the feedback indicates that the worker is not reliable, the machine learning component 246 may adjust the balance threshold rules 242 to restrict the worker's commission balance thresholds 236.

In some examples, the machine learning component 246 comprises a trained regressor such as a random decision forest, directed acyclic graph, support vector machine, neural network, or other trained regressor. The trained regressor may be trained using the feedback data described above. Examples of trained regressors include a convolutional neural network and a random decision forest. It should further be understood that the machine learning component 246, in some examples, may operate according machine learning principles and/or techniques known in the art without departing from the systems and/or methods described herein.

The machine learning component 246 is arranged to execute the methods described herein to determine balance threshold rule adjustments in a manner which allows for improved performance when determining commission balance thresholds 236 at the commission manager 202.

In an example, the machine learning component 246 or other machine learning engine may make use of training data pairs when applying machine learning techniques and/or algorithms. Millions of training data pairs (or more) may be stored in a machine learning data structure. In some examples, a training data pair includes a feedback data value paired with a balance threshold rule adjustment value. The pairing of the two values demonstrates a relationship between the feedback data value and the balance threshold rule adjustment value that may be used by the machine learning component 246 to determine future balance threshold rule adjustments according to machine learning techniques and/or algorithms.

In some examples, the machine learning component 246 may be located on another computing device with which the commission manager 202 is in communication, such as a server associated with a service provider company or other entity. It should be understood that other arrangements of the software modules in the commission manager 202 and related computing devices may be used without departing from the description herein.

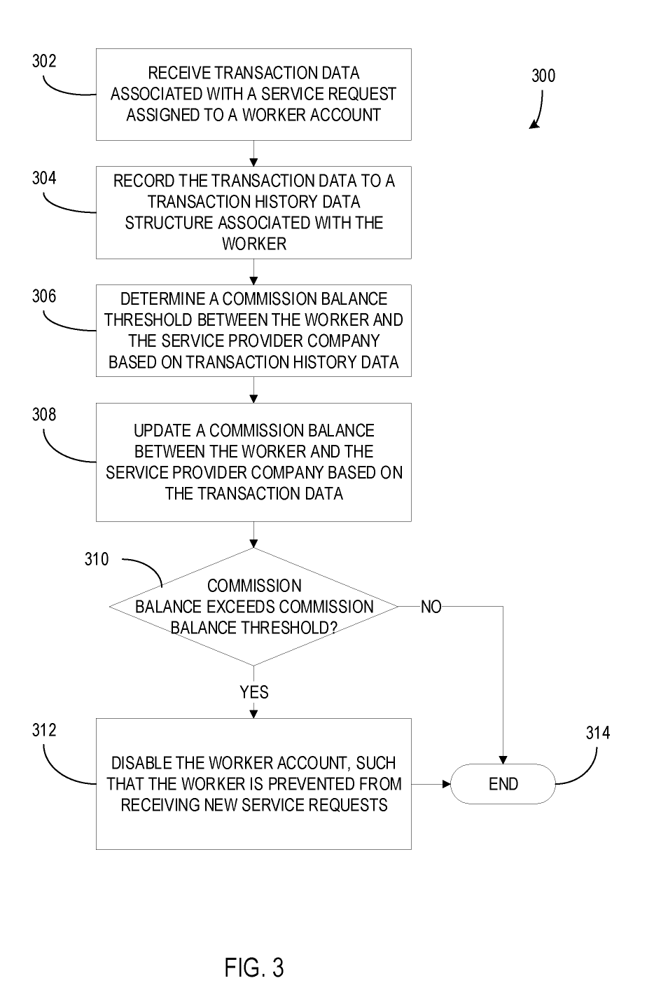

FIG. 3 is an exemplary flow chart 300 illustrating enforcing a commission balance threshold between a worker and service provider company based on transaction history data according to an embodiment. The process described in FIG. 3 may occur in one or more software modules, such as the commission manager 202 of FIG. 2. At 302, transaction data associated with a service request assigned to a worker account is received. The transaction data may be received by a commission manager (e.g., commission manager 102, etc.) from a party to the transaction and/or an entity associated with the transaction (e.g., the worker 104, a service provider company 106 or 108, etc.). For instance, the worker 104 may input transaction data into a computing device that communicates the transaction data to the commission manager 102. Alternatively, or additionally, service provider companies 106 and 108 may communicate transaction data to the commission manager 102 electronically over a network.

At 304, the transaction data is recorded to a transaction history data structure associated with the worker. The transaction history data structure may be in or otherwise associated with the worker account of the worker. In some examples, a commission manager (e.g., commission manager 102, 202, etc.) may determine a worker (e.g., worker 104, etc.) and a service provider company (e.g., service provider companies 106, 108, etc.) associated with the received transaction data and identify a worker account associated with the worker and service provider company. The transaction data is then recorded in the transaction history data structure of the identified worker account, the transaction data being merged with other transaction history data therein. Alternatively, the transaction history data structure may reside apart from specific worker accounts and, instead, store all transaction history data associated with a worker across all service provider companies for whom the worker works.

At 306, a commission balance threshold between the worker and the service provider company is determined based on transaction history data. The commission balance threshold determination may further be based on defined balance threshold rules as described herein. Evaluation of the balance threshold rules may depend on one or more transaction history data values, groups or categories of transaction history data values, and/or data values derived from transaction history data values (e.g., sums of data values, averages of data values, maximums and/or minimums of groups of data values, etc.). The transaction history data values needed to evaluate the balance threshold rules are accessed from the transaction history data structure. The commission balance threshold or thresholds associated with the worker account may then be determined, updated, adjusted, created, and/or removed based on the results of evaluating the balance threshold rules.

At 308, a commission balance between the worker and the service provider company is updated based on the received transaction data. In an example, the transaction amount is accessed from the received transaction data and a commission amount is calculated based on the transaction amount (e.g., a commission amount may be a percentage of the total transaction amount, etc.). The commission amount and/or transaction amount are used to update the commission balance of the worker account associated with the worker and service provider company.

If, at 310, the commission balance exceeds the commission balance threshold, the worker account is disabled at 312, such that the worker is prevented from receiving new service requests at that worker account. Disabling the worker account may include notifying the associated service provider company that the commission balance threshold is exceeded, such that the service provider company does not send any additional service requests to the worker until the commission balance is settled. For instance, a commission manager may use a notification API provided by a service provider company to provide a notification that a worker has exceeded a commission balance threshold. Alternatively, or additionally, other actions may be taken by the commission manager and/or the service provider company to enforce commission balance thresholds, such as warnings or notifications, time limits for settling balances, requests that the worker contact the service provider company, etc.

Alternatively, if the commission balance does not exceed the commission balance threshold at 310, the process ends at 314.

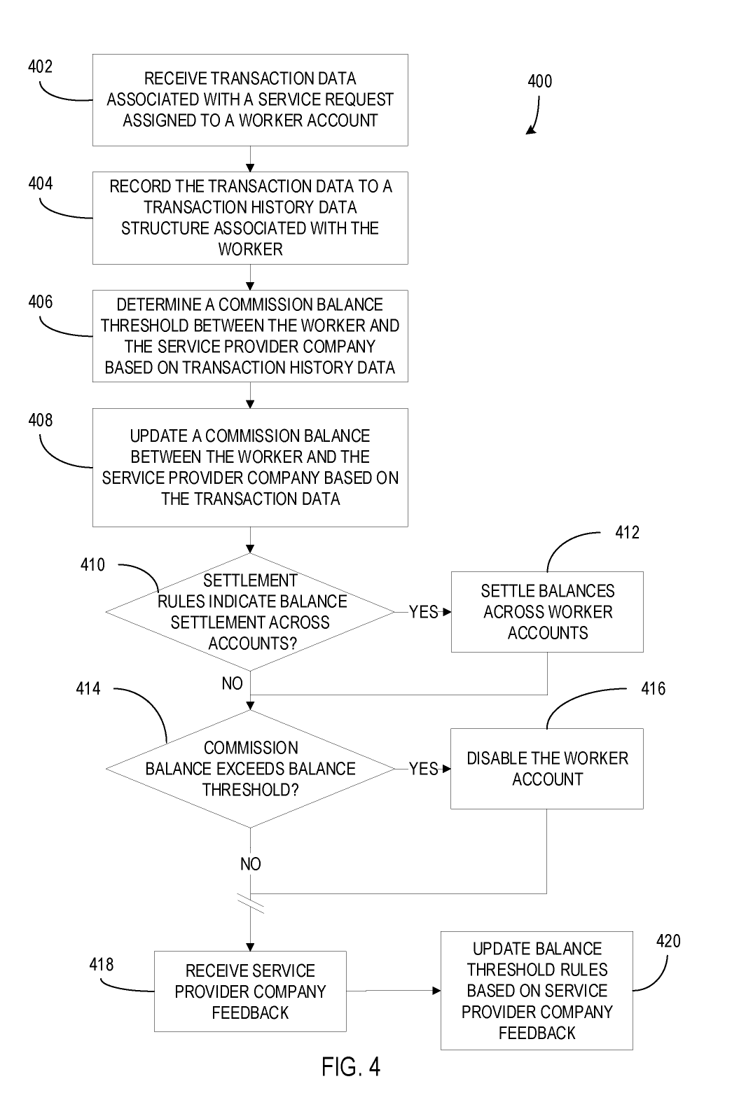

FIG. 4 is an exemplary flow chart illustrating enforcing a commission balance threshold between a worker and a service provider company as in FIG. 3, including settling commission balance differences between different service provider companies according to an embodiment. From 402 to 408, the transaction data is received, a commission balance threshold is determined, and the commission balance is updated in a substantially identical process as described above with respect to FIG. 3. At 410, balance settlement rules are evaluated to determine whether commission balances should be settled across worker accounts. If the settlement rules indicate that balances should be settled, balances are settled across worker accounts at 412. After the balances are settled or if the settlement rules indicate that balances should not be settled, the process proceeds to 414.

If, at 414, the commission balance exceeds the balance threshold, the worker account is disabled at 416 as described above with respect to FIG. 13.

At a later time, at 418, service provider company feedback is received. In some examples, the service provider company feedback may be provided to a machine learning component (e.g., machine learning component 246, etc.). At 420, the service provider company feedback is used by the commission manager and/or an associated machine learning component to update the balance threshold rules. As described above, the machine learning component may update or adjust balance threshold rules based on the service provider company feedback using machine learning techniques.

Additional Example Scenarios

Aspects of the disclosure enable various additional scenarios, such as next described.

In an example, a driver works for two different ride provider companies. The driver can receive ride requests from each of the ride provider companies via an application on the driver's mobile phone. The driver receives a ride request associated with the first ride provider company from a client. The driver provides the client with the requested ride, and the client pays the driver in cash. The driver reports the cash transaction on the same mobile phone application upon which the driver receives ride requests.

The reported cash transaction is provided to a commission manager associated with an entity that is a trusted agent of both ride provider companies. The commission manager updates a commission balance between the worker and the first ride provider company based on the reported cash transaction and a commission balance threshold is determined based on the past transaction history data associated with the worker. The transaction history data indicates that the worker has carried a commission balance with the first ride provider company for an excessive amount of time, so the commission balance threshold is adjusted downward. With the addition of the cash transaction to the commission balance, the commission balance now exceeds the determined commission balance threshold. The commission manager notifies the first ride provider company of the exceeded threshold and the first ride provider company disables the worker's account, preventing additional ride requests from being assigned to the worker.

The worker is also notified that the commission balance threshold has been exceeded. The worker proceeds to a bank and settles the commission balance owed to the first ride provider company. The commission manager receives transaction data associated with the settlement of the commission balance, and, as a result of the commission balance now being less than the commission balance threshold, the commission manager notifies the first ride provider company to enable the worker's account again.

In a related example, the worker is owed a commission balance by the first ride provider company and owes a commission balance to the second ride provider company. The ride provider companies have agreements with the commission manager enabling the commission manager to settle balances across multiple accounts associated with a worker under defined conditions. The commission manager evaluates the defined settlement rules and determines that settlement is available in this case. The commission manager transfers a portion of the commission balance owed to the worker by the first ride provider company to the commission balance owed to the second ride provider by the worker. The first amount exceeds the second amount, so that the amount owed by the worker to the second ride provider is reduced to zero, while the amount owed to the worker by the first ride provider is reduced.

Exemplary Operating Environment

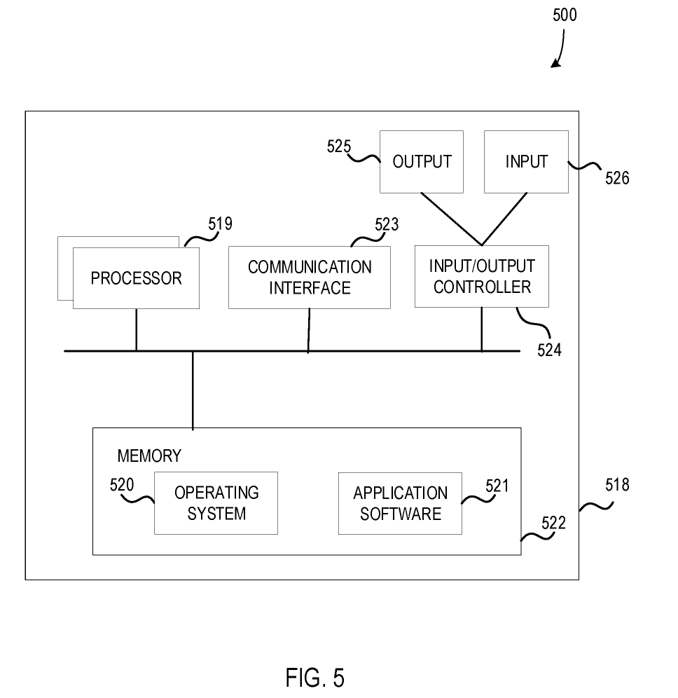

The present disclosure is operable with a computing apparatus according to an embodiment as a functional block diagram 500 in FIG. 5. In an embodiment, components of a computing apparatus 518 may be implemented as a part of an electronic device according to one or more embodiments described in this specification. The computing apparatus 518 comprises one or more processors 519 which may be microprocessors, controllers or any other suitable type of processors for processing computer executable instructions to control the operation of the electronic device. Platform software comprising an operating system 520 or any other suitable platform software may be provided on the apparatus 518 to enable application software 521 to be executed on the device. According to an embodiment, determining a commission balance threshold based on transaction history data and enforcing the commission balance threshold by disabling a worker account as described herein may be accomplished by software.

Computer executable instructions may be provided using any computer-readable media that are accessible by the computing apparatus 518. Computer-readable media may include, for example, computer storage media such as a memory 522 and communications media. Computer storage media, such as a memory 522, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that the storage may be distributed or located remotely and accessed via a network or other communication link (e.g. using a communication interface 523).

The computing apparatus 518 may comprise an input/output controller 524 configured to output information to one or more output devices 525, for example a display or a speaker, which may be separate from or integral to the electronic device. The input/output controller 524 may also be configured to receive and process an input from one or more input devices 526, for example, a keyboard, a microphone or a touchpad. In one embodiment, the output device 525 may also act as the input device. An example of such a device may be a touch sensitive display. The input/output controller 524 may also output data to devices other than the output device, e.g. a locally connected printing device. In some embodiments, a user may provide input to the input device(s) 526 and/or receive output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:

A system for enforcing a commission balance threshold between a worker and a service provider company, the system comprising:

at least one processor;

at least one memory comprising computer program code, the at least one memory and computer program code configured to, with the at least one processor, cause the at least one processor to:

receive transaction data associated with a service request assigned to a worker account of the worker, the worker account associated with the service provider company;

record the transaction data to a transaction history data structure associated with the worker;

determine a commission balance threshold between the worker and the service provider company based on transaction history data of the transaction history data structure, the transaction history data including the recorded transaction data;

update a commission balance between the worker and the service provider company based on the recorded transaction data, the commission balance representing an amount owed to either the worker or the service provider company; and

upon the updated commission balance exceeding the commission balance threshold, disable the worker account, such that the worker is prevented from receiving new service requests.

The system described above, wherein the worker has worker accounts with multiple service provider companies, the worker accounts including commission balances between the worker and the multiple service provider companies; and

the at least one memory and computer program code are configured to, with the at least one processor, further cause the at least one processor to settle differences in the commission balances between the multiple service provider companies.

The system described above, wherein determining a commission balance threshold based on transaction history data of the transaction history data structure includes determining a commission balance threshold based on at least one of a frequency of commission transfers, an average commission balance value, and a ratio of cash transactions to total transactions.

The system described above, wherein the commission balance threshold includes a threshold time period; and

wherein disabling the worker account is based on exceeding the commission balance threshold for longer than the threshold time period.

The system described above, wherein the threshold time period is defined based on a frequency of a commission balance threshold being exceeded in the transaction history data.

The system described above, the at least one memory and computer program code configured to, with the at least one processor, further cause the at least one processor to enable the worker account when the worker account is disabled and the commission balance is less than the commission balance threshold.

A computerized method for enforcing a commission balance threshold between a worker and a service provider company, the method comprising:

receiving transaction data associated with a service request assigned to a worker account of the worker, the worker account associated with the service provider company;

recording the transaction data to a transaction history data structure associated with the worker;

determining a commission balance threshold between the worker and the service provider company based on transaction history data of the transaction history data structure, the transaction history data including the recorded transaction data;

updating a commission balance between the worker and the service provider company based on the recorded transaction data, the commission balance representing an amount owed to either the worker or the service provider company; and

upon the updated commission balance exceeding the commission balance threshold, disabling the worker account, such that the worker is prevented from receiving new service requests.

The computerized method described above, wherein the worker has worker accounts with multiple service provider companies, the worker accounts including commission balances between the worker and the multiple service provider companies; and

the computerized method further comprising settling differences in the commission balances between the multiple service provider companies.

The computerized method described above, wherein determining a commission balance threshold based on transaction history data of the transaction history data structure includes determining a commission balance threshold based on transaction history data indicating at least one of a frequency of commission settlements, an average commission balance value, and an average ratio of cash transactions to total transactions.

The computerized method described above, wherein the commission balance threshold includes a threshold time period; and

wherein disabling the worker account is based on exceeding the commission balance threshold for longer than the threshold time period.

The computerized method described above, wherein the threshold time period is defined based on a frequency of a commission balance threshold being exceeded in the transaction history data.

The computerized method described above, further comprising enabling the worker account when the worker account is disabled and the commission balance is less than the commission balance threshold.

The computerized method described above, wherein determining a commission balance threshold between the worker and the service provider company based on transaction history data of the transaction history data structure includes evaluating balance threshold rules using the transaction history data;

the computerized method further comprising:

receiving feedback associated with the determined commission balance threshold; and

adjusting the balance threshold rules based on the received feedback using machine learning techniques.

The computerized method described above, wherein receiving transaction data associated with a service request assigned to a worker account of the worker includes receiving cash transaction data from the worker via a worker application on a computing device of the worker.

The computerized method described above, wherein determining a commission balance threshold between the worker and the service provider company includes determining a commission balance threshold between the worker and the service provider company based on rules defined by the service provider company.

One or more computer storage media having computer-executable instructions for enforcing a commission balance threshold between a worker and a service provider company that, upon execution by a processor, cause the processor to at least:

receive transaction data associated with a service request assigned to a worker account of the worker, the worker account associated with the service provider company;

record the transaction data to a transaction history data structure associated with the worker;

determine a commission balance threshold between the worker and the service provider company based on transaction history data of the transaction history data structure, the transaction history data including the recorded transaction data;

update a commission balance between the worker and the service provider company based on the recorded transaction data, the commission balance representing an amount owed to either the worker or the service provider company; and

upon the updated commission balance exceeding the commission balance threshold, disable the worker account, such that the worker is prevented from receiving new service requests.

The one or more computer storage media described above, wherein the worker has worker accounts with multiple service provider companies, the worker accounts including commission balances between the worker and the multiple service provider companies; and

the computer-executable instructions, upon execution by a processor, further cause the processor to settle differences in the commission balances between the multiple service provider companies.

The one or more computer storage media described above, wherein determining a commission balance threshold based on transaction history data of the transaction history data structure includes determining a commission balance threshold based on at least one of a frequency of commission transfers, an average commission balance value, and a ratio of cash transactions to total transactions.

The one or more computer storage media described above, wherein the commission balance threshold includes a threshold time period; and

wherein disabling the worker account is based on exceeding the commission balance threshold for longer than the threshold time period.

The one or more computer storage media described above, wherein the threshold time period is defined based on a frequency of a commission balance threshold being exceeded in the transaction history data.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for facilitating a transaction by determining commission balance thresholds based on transaction history data in combination with defined balance threshold rules. The illustrated one or more processors 519 together with the computer program code stored in memory 522 constitute exemplary processing means for determining and enforcing commission balance thresholds associated with workers accounts based on balance threshold rules as well as settling commission balances across multiple worker accounts.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for enforcing a commission balance threshold between a worker and a service provider company, the system comprising:
at least one processor;
at least one memory comprising computer program code, the at least one memory and computer program code configured to, with the at least one processor, cause the at least one processor to:
receive transaction data associated with a service request assigned to a worker account of the worker, the worker account associated with the service provider company;
record the transaction data to a transaction history data structure associated with the worker;
determine a commission balance threshold between the worker and the service provider company based on transaction history data of the transaction history data structure, the transaction history data including the recorded transaction data;
update a commission balance between the worker and the service provider company based on the recorded transaction data, the commission balance representing an amount owed to either the worker or the service provider company; and
upon the updated commission balance exceeding the commission balance threshold, disable the worker account, such that the worker is prevented from receiving new service requests.

2. The system of claim 1, wherein the worker has worker accounts with multiple service provider companies, the worker accounts including commission balances between the worker and the multiple service provider companies; and
the at least one memory and computer program code are configured to, with the at least one processor, further cause the at least one processor to settle differences in the commission balances between the multiple service provider companies.

3. The system of claim 1, wherein determining a commission balance threshold based on transaction history data of the transaction history data structure includes determining a commission balance threshold based on transaction history data indicating at least one of a frequency of commission transfers, an average commission balance value, and a ratio of cash transactions to total transactions.

4. The system of claim 1, wherein the commission balance threshold includes a threshold time period; and
wherein disabling the worker account is based on exceeding the commission balance threshold for longer than the threshold time period.

5. The system of claim 4, wherein the threshold time period is defined based on a frequency of a commission balance threshold being exceeded in the transaction history data.

6. The system of claim 1, the at least one memory and computer program code configured to, with the at least one processor, further cause the at least one processor to enable the worker account when the worker account is disabled and the commission balance is less than the commission balance threshold.

7. A computerized method for enforcing a commission balance threshold between a worker and a service provider company, the method comprising:
receiving transaction data associated with a service request assigned to a worker account of the worker, the worker account associated with the service provider company;
recording the transaction data to a transaction history data structure associated with the worker;
determining a commission balance threshold between the worker and the service provider company based on transaction history data of the transaction history data structure, the transaction history data including the recorded transaction data;
updating a commission balance between the worker and the service provider company based on the recorded transaction data, the commission balance representing an amount owed to either the worker or the service provider company; and
upon the updated commission balance exceeding the commission balance threshold, disabling the worker account, such that the worker is prevented from receiving new service requests.

8. The computerized method of claim 7, wherein the worker has worker accounts with multiple service provider companies, the worker accounts including commission balances between the worker and the multiple service provider companies; and
the computerized method further comprising settling differences in the commission balances between the multiple service provider companies.

9. The computerized method of claim 7, wherein determining a commission balance threshold based on transaction history data of the transaction history data structure includes determining a commission balance threshold based on transaction history data indicating at least one of a frequency of commission settlements, an average commission balance value, and an average ratio of cash transactions to total transactions.

10. The computerized method of claim 7, wherein the commission balance threshold includes a threshold time period; and
wherein disabling the worker account is based on exceeding the commission balance threshold for longer than the threshold time period.

11. The computerized method of claim 10, wherein the threshold time period is defined based on a frequency of a commission balance threshold being exceeded in the transaction history data.

12. The computerized method of claim 7, further comprising enabling the worker account when the worker account is disabled and the commission balance is less than the commission balance threshold.

13. The computerized method of claim 7, wherein determining a commission balance threshold between the worker and the service provider company based on transaction history data of the transaction history data structure includes evaluating balance threshold rules using the transaction history data;
the computerized method further comprising:
receiving feedback associated with the determined commission balance threshold; and
adjusting the balance threshold rules based on the received feedback using machine learning techniques.

14. The computerized method of claim 7, wherein receiving transaction data associated with a service request assigned to a worker account of the worker includes receiving cash transaction data from the worker via a worker application on a computing device of the worker.

15. The computerized method of claim 7, wherein determining a commission balance threshold between the worker and the service provider company includes determining a commission balance threshold between the worker and the service provider company based on rules defined by the service provider company.

16. One or more computer storage media having computer-executable instructions for enforcing a commission balance threshold between a worker and a service provider company that, upon execution by a processor, cause the processor to at least:
receive transaction data associated with a service request assigned to a worker account of the worker, the worker account associated with the service provider company;
record the transaction data to a transaction history data structure associated with the worker;
determine a commission balance threshold between the worker and the service provider company based on transaction history data of the transaction history data structure, the transaction history data including the recorded transaction data;
update a commission balance between the worker and the service provider company based on the recorded transaction data, the commission balance representing an amount owed to either the worker or the service provider company; and
upon the updated commission balance exceeding the commission balance threshold, disable the worker account, such that the worker is prevented from receiving new service requests.

17. The one or more computer storage media of claim 16, wherein the worker has worker accounts with multiple service provider companies, the worker accounts including commission balances between the worker and the multiple service provider companies; and
the computer-executable instructions, upon execution by a processor, further cause the processor to settle differences in the commission balances between the multiple service provider companies.

18. The one or more computer storage media of claim 16, wherein determining a commission balance threshold based on transaction history data of the transaction history data structure includes determining a commission balance threshold based on at least one of a frequency of commission transfers, an average commission balance value, and a ratio of cash transactions to total transactions.

19. The one or more computer storage media of claim 16, wherein the commission balance threshold includes a threshold time period; and
wherein disabling the worker account is based on exceeding the commission balance threshold for longer than the threshold time period.

20. The one or more computer storage media of claim 19, wherein the threshold time period is defined based on a frequency of a commission balance threshold being exceeded in the transaction history data.
